(19) United States
(12) Patent Application Publication
(10) Pub. No.: US 2017/0180764 A1
(43) Pub. Date: Jun. 22, 2017

(54) TIME LAPSE RECORDING VIDEO SYSTEMS

(71) Applicant: Carrier Corporation, Farmington, CT (US)

(72) Inventors: Sotirios KOUPAS, Pittsford, NY (US); Yevgenity SHAPIRO, Pittsford, NY (US)

(21) Appl. No.: 15/301,691

(22) PCT Filed: Mar. 10, 2015
(86) PCT No.: PCT/US2015/019583

§ 371 Date: Oct. 3, 2016

Related U.S. Application Data
(60) Provisional application No. 61/974,619, filed on Apr. 3, 2014.

(51) Int. Cl. H04N 21/2387; H04N 21/433; H04N 19/172; H04N 19/114; H04N 19/162

(52) U.S. Cl. CPC H04N 21/2387; H04N 19/114; H04N 19/162; H04N 19/172; H04N 21/4333; H04N 1/2133

(57) ABSTRACT

A system for time lapse video recording includes an image processing device configured to receive a compressed video that is encoded using a video compression module operative to encode video from a video camera using a video compression standard, wherein the image processing device is operative to control a time lapse rate to pick and store a plurality of image frames from the series of compressed image frames at the time lapse rate to create a time lapse video, wherein the image processing device is configured to cause the video compression module to modify a GOP length to achieve a predetermined time lapse video quality.

### CROSS-REFERENCE TO RELATED APPLICATIONS

This application claims priority to U.S. Provisional Patent Application No. 61/974,619 filed Apr. 3, 2014, which is incorporated by reference herein in its entirety.

### BACKGROUND

1. Field

The present disclosure relates to time lapse video recording, more specifically to time lapse video recording with block-oriented motion-compensation-based video compression standards.

2. Description of Related Art

M-JPEG is an intraframe-only compression scheme and is less computationally intensive than the technique of interframe prediction. Modern interframe video formats, such as MPEG1, MPEG2 and H.264/MPEG-4 AVC (Advanced Video Coding), achieve real-world compression-ratios of 1:50 or better, M-JPEG's lack of interframe prediction limits its efficiency to 1:20 or lower, depending on the tolerance to spatial artifacting in the compressed output. Because frames are compressed independently of one another, M-JPEG imposes lower processing and memory requirements on hardware devices but, as a tradeoff, also increases the required amount of storage space.

H.264/MPEG-4 Part 10 or AVC is one of the most commonly used video compression formats for the recording, compression, and distribution of video content. H.264/MPEG-4 AVC is a block-oriented motion-compensation-based video compression standard. Such compression standards take video as a series of key frames (I-frames) and partial frames (P-frames). The key frames are whole images (e.g., a JPEG) whereas a P-frame only includes an update based on the previous frame for any changed portions. Thus the P-frames require knowledge of the previous frames back to the last I-frame to compile an image at the time the P-frame was taken. Thus, time lapse recordings with H.264, MPEG-4, or the like, can lead to P-frames being selected that, on their own, have insufficient information to show an image or the image is severely degraded. Thus, time lapse recording is typically accomplished with MJPEG devices to ensure that each frame will be a whole image.

Such conventional methods and systems have generally been considered satisfactory for their intended purpose. However, there is still a need in the art for improved time lapse recording systems and methods. The present disclosure provides a solution for this problem.

### SUMMARY

In at least one aspect of this disclosure, a system for time lapse video recording includes an image processing device configured to receive a compressed video. The compressed video that the image processing device can receive is encoded using a video compression module (e.g., a video encoder) that is operative to encode video from a video camera using a video compression standard that is operative to compress a series of image frames into a plurality of key frames (I-frames) and at least one partial frame (P-frame) after at least one I-frame.

The video compression module is operative to modify a group of pictures length (GOP length) between I-frames such that the module controls an amount of P-frames after at least one I-frame (e.g., in between two I-frames) or a frame rate at which the I-frames or P-frames are taken. The system further includes an image processing device operative to control a time lapse rate to pick and store a plurality of image frames from the series of compressed image frames at the time lapse rate to create a time lapse video, wherein the image processing device is operative to cause the video compression module to modify the GOP length to achieve a predetermined time lapse video quality.

The video compression module can be operative to modify the GOP length such that the time lapse rate equals or is a multiple of the length of the GOP such that the image processing device only picks and stores I-frames to create the time lapse video.

The system can further include the video camera and the video compression module can be included in a video camera. In some embodiments, the system further includes the video compression module which can be included in any suitable portion of the systems, (e.g., the image processing device). In some embodiments, the video camera can include a GOP length selection interface that is operatively connected to the video compression module to modify the GOP length.

The image processing device can have a GOP length selection interface that is operatively connected to the video compression module to modify the GOP length.

In some embodiments, the video compression standard can be MPEG, MPEG-1, MPEG-2, MPEG-3, MPEG-4, H.264, or H.265 or any other suitable standard. The video compression standard can generally be a block-oriented motion-compensation-based video compression standard. In some embodiments, the image processing device can include a digital video receiver (DVR), a network video receiver (NVR), or a server.

The image processing device can be operative to sense an event and increase the time lapse rate during an event to pick and store a larger amount of image frames from the series of image frames during the event. The image processing device can also be operative to pick and store every image frame during the event and to revert to picking and storing image frames at the time lapse rate after the event.

In at least one aspect of this disclosure, a method includes setting a time lapse rate to pick a plurality of image frames from a series of image frames taken from a video camera, receiving an encoded video from a video compression module that is configured to encode a video from the video camera using a video compression standard to compress the series of image frames into a plurality of key frames (I-frames) and at least one partial frame (P-frame) after at least one I-frame, modifying a group of pictures length (GOP length) to match the time lapse rate by controlling an amount of P-frames after at least one I-frame or a frame rate at which the I-frames or P-frames are taken, and picking and storing the plurality of image frames from the series of image frames at the time lapse rate to create a time lapse video.

The modifying step can further include modifying the GOP length such that the plurality of image frames that are picked during the picking step are all I-frames for maximum time lapse video quality. The method can further include detecting an event and/or picking and storing all image frames during the event.

In some embodiments, the method further includes increasing the frame rate of the video camera during the event. The method can further include decreasing the GOP length during the event to maximize the number of I-frames picked and stored during the event. The method can further include modifying the GOP length to maximize an event video quality during the event.

In at least one aspect of this disclosure, a non-transitory computer readable medium can have a list of instructions executable by a processor, wherein the list of instructions includes receiving a time lapse rate to pick a plurality of images from a series of images taken from a video camera, and modifying a group of pictures length (GOP length) to match the time lapse rate by controlling an amount of partial frames (P-frames) after at least one key frame (I-frame) or a frame rate at which the I-frames or P-frames are taken. The list of instructions can further include picking the plurality of image frames from the series of image frames at the time lapse rate to create a time lapse video.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a systematic view of an embodiment of a system in accordance with this disclosure;

FIG. 2 is a systematic view of another embodiment of a system in accordance with this disclosure;

FIG. 3 is a diagrammatic view of a series of image frames in accordance with this disclosure, showing the GOP length unmodified so that frames are picked at a time lapse rate that is not matched with the GOP length such that both I-frames and P-frames get pulled; and

FIG. 4 is a diagrammatic view of a series of image frames in accordance with this disclosure, showing the GOP length modified so that frames are picked at a time lapse rate are substantially matched with the GOP length such that only I-frames get pulled.

### DETAILED DESCRIPTION

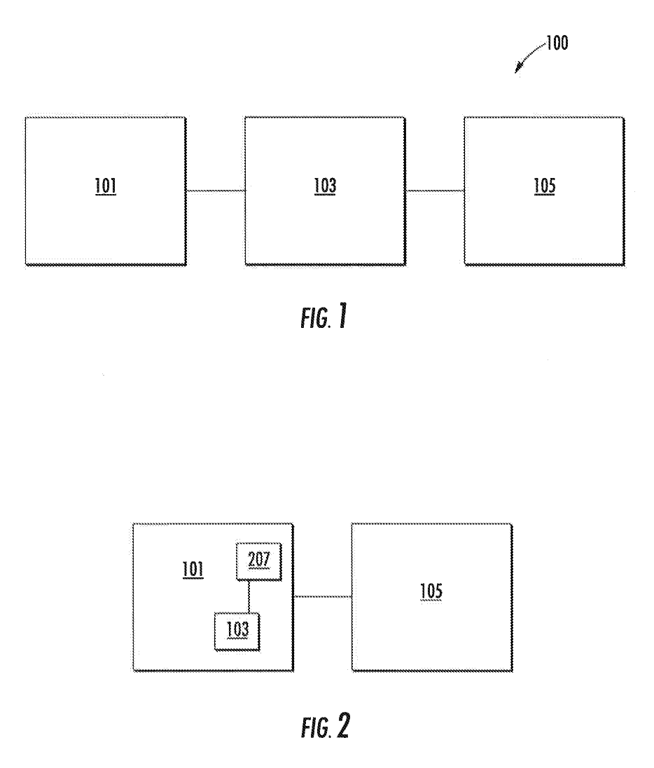

Reference will now be made to the drawings wherein like reference numerals identify similar structural features or aspects of the subject disclosure. For purposes of explanation and illustration, and not limitation, a systematic view an embodiment of the system in accordance with the disclosure is shown in FIG. 1 and is designated generally by reference character 100. Other embodiments of the system, or aspects thereof, are shown in FIGS. 2-4. The systems and methods described herein can be used to reduce storage space and computing requirements for time lapse video recording.

In at least one aspect of this disclosure, a system 100 for time lapse video recording includes an image processing device 105 which can receive a video compressed/encoded by a video compression module 103. The video compression module 103 can be operative to encode video from a video camera 101 using a video compression standard. The video camera 101 can be any suitable imaging device for capturing images, e.g., a digital surveillance camera. Video compression as used herein is to reduce the amount of data in a given video to reduce the amount of required storage space or bandwidth. As shown specifically in FIG. 2, the video compression module 103 can be included in the video camera 101. In some embodiments, the video compression module 103 can be included in image processing device 105 separate from the camera.

The video compression standard associated with the video compression module 103 can be operative to compress a series of image frames into a plurality of key frames (I-frames) and at least one partial frame (P-frame) after at least one I-frame. An I-frame is a frame where an entire image is taken for storage, whereas a P-frame is a frame that only updates a portion of the previous image based on changes between the P-frame image and the previous frame. Thus, an I-frame alone shows an entire picture, but a P-frame alone (without reference to any preceding frames) would only show pixilation of the changed portions of the previous image. Thus, the amount of data to store a series of image frames compressed in this manner versus a series of full image frames is reduced. However, to use a P-frame to create an image, every frame preceding the P-frame up to the last I-frame must be known and compiled together, which requires computational resources. In some embodiments, the video compression standard can be a block-oriented motion-compensation-based video compression standard. In some embodiments, the video compression standard can be MPEG, MPEG-1, MPEG-2, MPEG-3, MPEG-4, H.264, or H.265 or any other suitable standard.

When compressing a series of images in such a manner, the distance between adjacent I-frames is referred to as a group of pictures (GOP) length (see FIG. 3). In some embodiments, the video camera 101 can include a GOP length selection interface 207 (see FIG. 2) that is operatively connected to the video compression module 103 to manually modify the GOP length. Shortening the GOP length increases the amount of I-frames in a given amount of image frames, which can increases quality but at the cost of increasing data storage space required. Lengthening the GOP length will reduce the amount of I-frames for a given amount of image frames which may reduce quality, but decreases the amount of required data storage (and increases the use of computational resources).

The video compression module 103 can be operative to modify the GOP length between I-frames such that the module 103 controls an amount of P-frames after at least one I-frame. Alternatively or additionally, the video compression module 103 can be operative to modify a frame rate at which the I-frames or P-frames are taken to effectively change the GOP length as a function of time. The video compression module 103 can include any suitable computer, microprocessor, circuitry, software (e.g., program instructions/code), hardware, or the like.

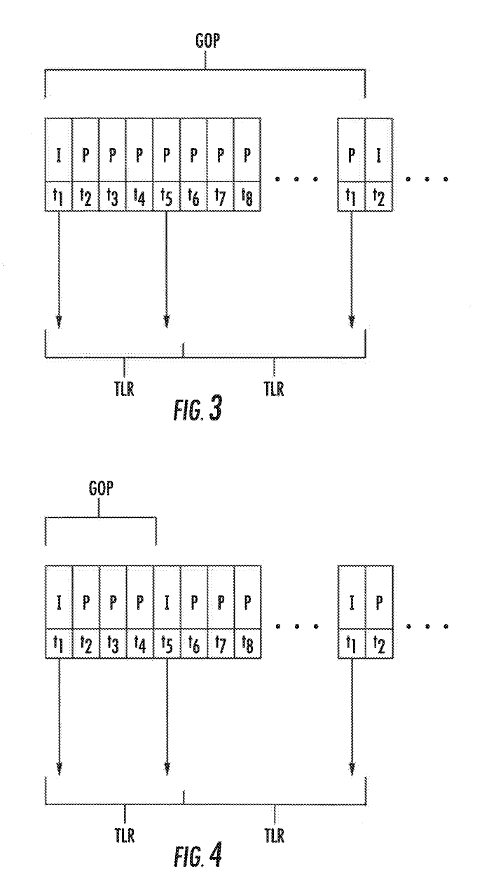

The image processing device 105 is operative to control a time lapse rate to pick and store a plurality of image frames from the series of compressed image frames (e.g. image series 300, see FIGS. 3 and 4) at the time lapse rate (TLR) to create a time lapse video. The image processing device 105 can include any suitable computer, microprocessor, circuitry, software (e.g., program instructions/code), hardware, or the like (e.g., a DVR, NVR, or server). In some embodiments, the image processing device 105 may include any suitable user interface and/or a display.

When a time lapse rate is selected by the image processing device 105 or by a user of the image processing device 105, the image processing device 105 can cause the video compression module 103 to modify the GOP length to achieve a predetermined time lapse video quality for the selected time lapse rate (e.g. for a predetermined amount of data/required storage space).

Referring to FIG. 4, in some embodiments, the image processing device 105 can cause the video compression module 103 to modify the GOP length such that the time lapse rate matches (e.g., equals or is a multiple of) the length of the GOP such that the image processing device only picks and stores I-frames to create the time lapse video at the selected time lapse rate. In such an embodiment, a user can input or select a time lapse rate using the image processing device 105, and the image processing device 105 can communicate, instruct, and/or otherwise cause the video compression module 103 to automatically adjust the GOP length to the suitable length (e.g. for a predetermined quality and/or to match I-frames with time lapse rate).

In some embodiments, the image processing device 105 can also have a manual GOP length selection interface that is operatively connected to the video compression module 103 to modify the GOP length. For example, the user can input a desired time lapse rate to the image processing device 105 which can then determine a suitable GOP length as disclosed herein. The image processing device 105 can then display the suitable GOP length (or a plurality thereof) to the user and the user can modify the GOP length using the GOP length selection interface as desired. The image processing device 105 can also be operative to determine, predict, and/or display the amount of data storage required for a selected GOP length.

In some embodiments, the image processing device 105 can receive an input of a usable storage space and then determine the proper time lapse rate and/or GOP setting to store no more than the usable storage space.

The image processing device 105 can be operative to sense an event and increase the time lapse rate during an event to pick and store a larger amount of image frames from the series of images frames during the event. The image processing device can also be operative to pick and store every image frame during the event and to revert to picking and storing image frames at the time lapse rate after the event. For example, a security camera system can be operative to create a time lapse video at a time lapse rate as disclosed herein. If a person walks in view of the camera, the image processing device 105 can sense this using any suitable means and can either bypass the video compression module to store every full image taken from the camera or to shorten the GOP length to increase video quality (e.g., to maximize I-frames).

In at least one aspect of this disclosure, a method includes setting a time lapse rate to pick a plurality of image frames from a series of image frames taken from a video camera, receiving an encoded video from a video compression module that is configured to encode a video from the video camera using a video compression standard to compress the series of image frames into a plurality of key frames (I-frames) and at least one partial frame (P-frame) after at least one I-frame, modifying the GOP length to match the time lapse rate by controlling an amount of P-frames after at least one I-frame or a frame rate at which the I-frames or P-frames are taken, and picking and storing the plurality of image frames from the series of image frames at the time lapse rate to create a time lapse video.

The modifying step can further include modifying the GOP length such that the plurality of image frames that are picked during the picking step are all I-frames for maximum time lapse video quality. The method can further include detecting an event and/or picking and storing all image frames during the event.

In some embodiments, the method further includes increasing the frame rate of the video camera during the event. The method can further include decreasing the GOP length during the event to maximize the number of I-frames picked and stored during the event. The method can further include modifying the GOP length to maximize an event video quality during the event.

In at least one aspect of this disclosure, a non-transitory computer readable medium can have a list of instructions executable by a processor, wherein the list of instructions includes receiving a time lapse rate to pick a plurality of images from a series of images taken from a video camera, and modifying a GOP length to match the time lapse rate by controlling an amount of P-frames after at least one I-frame or a frame rate at which the I-frames or P-frames are taken. The list of instructions can further include picking the plurality of image frames from the series of image frames at the time lapse rate to create a time lapse video.

As will be appreciated by one skilled in the art, aspects of this disclosure may be embodied as a system, method or computer program product. Accordingly, aspects of this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure are described herein with reference to methods, apparatus (systems) and computer program products according to embodiments of this disclosure. It will be understood that each portion, and combinations of portions, of the method(s) described herein can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts herein disclosed.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act disclosed herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts disclosed herein.

As described herein, the number of P-frames between the I-frames is controlled by the GOP length setting. Some compression module implementations can allow for this setting to be configurable in order to provide the ability to the end user to select the desired trade-off between video quality and storage requirements. The system described herein can take advantage of this ability to control the GOP length in order to achieve predetermined time lapse video quality during time-lapse recording.

The methods and systems of the present disclosure, as described above and shown in the drawings, provide for a time lapse video system using a video compression. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A system for time lapse video recording, comprising;
an image processing device configured to receive a compressed video, wherein the compressed video is encoded using a video compression module that is operative to encode video from a video camera using a video compression standard, wherein the video compression standard is operative to compress a series of image frames into a plurality of key frames (I-frames) and at least one partial frame (P-frame) after at least one I-frame, wherein the video compression module is operative to modify a group of pictures length (GOP length) between I-frames such that the module controls an amount of P-frames after at least one I-frame or a frame rate at which the I-frames or P-frames are taken, and
wherein the image processing device is operative to control a time lapse rate to pick and store a plurality of image frames from the series of compressed image frames at the time lapse rate to create a time lapse video, wherein the image processing device is configured to cause the video compression module to modify the GOP length to achieve a predetermined time lapse video quality.

2. The system of claim 1, wherein image processing device is configured to cause the video compression module to modify the GOP length such that the time lapse rate equals or is a multiple of the length of the GOP such that the image processing device only picks and stores I-frames to create the time lapse video.

3. The system of claim 1, further comprising the video camera, wherein the video compression module is included in the video camera.

4. The system of claim 1, further comprising the video compression module, wherein the video compression module is included in the image processing device.

5. The system of claim 1, wherein the video camera includes a GOP length selection interface that is operatively connected to the video compression module to modify the GOP length.

6. The system of claim 1, wherein the image processing device includes a GOP length selection interface that is operatively connected to the video compression to cause the video compression module to modify the GOP length.

7. The system of claim 1, wherein the video compression standard is MPEG, MPEG-1, MPEG-2, MPEG-3, MPEG-4, H.264, or H.265.

8. The system of claim 1, wherein the image processing device is operative to sense an event and increase the time lapse rate during an event to pick and store a larger amount of image frames from the series of images frames during the event.

9. The system of claim 8, wherein the image processing device is operative to pick and store every image frame during the event and to revert to picking and storing image frames at the time lapse rate after the event.

10. The system of claim 1, wherein the video compression standard is a block-oriented motion-compensation-based video compression standard.

11. The system of claim 1, wherein image processing device includes a digital video receiver, a network video receiver, or a server.

12. A method, comprising:
setting a time lapse rate to pick a plurality of image frames from a series of image frames taken from a video camera;
receiving an encoded video from a video compression module that is configured to encode a video from the video camera using a video compression standard to compress the series of image frames into a plurality of key frames (I-frames) and at least one partial frame (P-frame) after at least one I-frame;
modifying a group of pictures length (GOP length) of the video compression module to match the time lapse rate by controlling an amount of P-frames after at least one I-frame or a frame rate at which the I-frames or P-frames are taken; and
picking and storing the plurality of image frames from the series of image frames at the time lapse rate to create a time lapse video.

13. The method of claim 12, wherein the modifying step further includes modifying the GOP length such that the plurality of image frames that are picked during the picking step are all I-frames for maximum time lapse video quality.

14. The method of claim 12, further comprising detecting an event.

15. The method of claim 14, further comprising picking and storing all image frames during the event.

16. The method of claim 14, further comprising increasing the frame rate of the video camera during the event.

17. The method of claim 14, further comprising decreasing the GOP length during the event to maximize the number of I-frames picked and stored during the event.

18. The method of claim 14, further comprising modifying the GOP length to maximize an event video quality during the event.

19. A non-transitory computer readable medium including a list of instructions executable by a processor, the list of instructions including:
receiving a time lapse rate to pick a plurality of images from a series of images taken from a video camera; and
modifying a group of pictures length (GOP length) to match the time lapse rate by controlling an amount of partial frames (P-frames) after at least one key frame (I-frame) or a frame rate at which the I-frames or P-frames are taken.

20. The non-transitory computer readable medium of claim 19, wherein the list of instructions further includes picking the plurality of image frames from the series of image frames at the time lapse rate to create a time lapse video.
